(19) United States
(12) Patent Application Publication
(10) Pub. No.: US 2020/0168221 A1
(43) Pub. Date: May 28, 2020

(54) VOICE RECOGNITION APPARATUS AND METHOD OF VOICE RECOGNITION

(71) Applicant: Mitsubishi Electric Corporation, Tokyo (JP)

(72) Inventor: Yusuke SETO, Tokyo (JP)

(73) Assignee: Mitsubishi Electric Corporation, Tokyo (JP)

(21) Appl. No.: 16/617,408

(22) PCT Filed: Aug. 8, 2017
(86) PCT No.: PCT/JP2017/028694

§ 371 Date: Nov. 26, 2019

(51) Int. Cl. G10L 15/22; G10L 13/04; G10L 15/04; G10L 15/10

(52) U.S. Cl. CPC G10L 15/22; G10L 13/043; G10L 2015/223; G10L 15/10; G10L 15/04

(57) ABSTRACT

An object of the present invention is to provide a voice recognition apparatus and method of voice recognition capable of improving operability in user's device operation by voice. A voice recognition apparatus in the present invention includes the following: a voice acquiring unit that acquires a voice of a user; a voice recognizing unit that recognizes a most-likely term from among predetermined terms, with regard to the voice acquired by the voice acquiring unit; a voice-segment identifying unit that identifies a voice segment from the start of the most-likely term recognized by the voice recognizing unit to a position at which the difference between the likelihood of the most-likely term and the likelihood of a second-most-likely term equals or exceeds a predetermined threshold; and a sound output controller that controls sound output of the voice corresponding to the voice segment identified by the voice-segment identifying unit.

### TECHNICAL FIELD

The present invention relates to a voice recognition apparatus that performs voice recognition when a user operates a device through his/her voice. The present invention also relates to a method of such voice recognition.

### BACKGROUND ART

When a user operates a device by voice, failure to correctly utter a term that relates to a device operation and is previously entered in the device prevents the device from receiving the user's voice as an operational command. For a long operation-related term in particular, the user needs to memorize the long term in order to execute his/her desired operation, and such a long term consumes time for executing the operation.

To address these problems, conventionally disclosed is a technique of omitting a user's utterance in device operation (c.f., Patent Documents 1 and 2). Patent Document 1 discloses establishing a hierarchy in which voice recognition can be performed on an operation-related term, and receiving a user's utterance as an operational command not only when the user utters an entire term from the term at the top of the hierarchy, but also when the user starts to utter from the preceding term at some midpoint of the hierarchy, thus enabling omission of the user's utterance in device operation.

Patent Document 2 discloses defining, in advance, an abbreviation of an operation-related term, and estimating an operation corresponding to the abbreviation uttered by the user, from the status of current application use and from information about user operations in the past, thus enabling omission of the user's utterance in device operation.

### PRIOR ART DOCUMENTS

### Patent Documents

Patent Document 1: Japanese Patent Application Laid-Open No. 11-38994

Patent Document 2: Japanese Patent Application Laid-Open No. 2016-114395

### SUMMARY

### Problem to be Solved by the Invention

The technique in Patent Document 1 can unfortunately omit a user's utterance, only in particular use, i.e., only when the user starts to utter from what he/she uttered the last time. Furthermore, the technique fails to reflect an instance where utterance omission can produce a synonymous word or phrase, and hence leads to a low success rate in the voice recognition of the user's utterance.

The technique in Patent Document 2 requires the user to define an abbreviation in advance. Furthermore, the device in this technique can execute an operation that is not intended by the user, because it estimates an operation corresponding to the abbreviation.

These conventional techniques do not provide high operability when the user operates the device by voice.

To solve this problem, it is an object of the present invention to provide a voice recognition apparatus and method of voice recognition capable of improving operability in user's device operation by voice.

### Means to Solve the Problem

To solve the problem, an embodiment of the present invention provides a voice recognition apparatus that includes the following: a voice acquiring unit that acquires a voice of a user; a voice recognizing unit that recognizes a most-likely term from among a plurality of predetermined terms, with regard to the voice acquired by the voice acquiring unit; a voice-segment identifying unit that identifies a voice segment from the start of the most-likely term recognized by the voice recognizing unit to a position at which the difference between the likelihood of the most-likely term and the likelihood of a second-most-likely term equals or exceeds a predetermined threshold; and a sound output controller that controls sound output of the voice corresponding to the voice segment identified by the voice-segment identifying unit.

Another embodiment of the present invention provides a voice recognition apparatus that includes the following: a voice acquiring unit that acquires a voice of a user; a voice recognizing unit that recognizes a most-likely term from among a plurality of predetermined terms, with regard to the voice acquired by the voice acquiring unit; a character-string identifying unit that identifies a character string from the start of the most-likely term recognized by the voice recognizing unit to a position at which the difference between the likelihood of the most-likely term and the likelihood of a second-most-likely term equals or exceeds a predetermined threshold; and a display controller that controls display of the character string identified by the character-string identifying unit.

A still another embodiment of the present invention provides a method of voice recognition that includes the following: acquiring a voice of a user; recognizing a most-likely term from among a plurality of predetermined terms, with regard to the acquired voice; identifying a voice segment from the start of the recognized most-likely term to a position at which the difference between the likelihood of the most-likely term and the likelihood of a second-most-likely term equals or exceeds a predetermined threshold; and controlling sound output of the voice corresponding to the identified voice segment.

A further another embodiment of the present invention provides a method of voice recognition that includes the following: acquiring a voice of a user; recognizing a most-likely term from among a plurality of predetermined terms, with regard to the acquired voice; identifying a character string from the start of the recognized most-likely term to a position at which the difference between the likelihood of the most-likely term and the likelihood of a second-most-likely term equals or exceeds a predetermined threshold; and controlling display of the identified character string.

### Effects of the Invention

According to the embodiment of the present invention, the voice recognition apparatus includes the following: the voice acquiring unit, which acquires a voice of a user; the voice recognizing unit, which recognizes a most-likely term from among a plurality of predetermined terms, with regard to the voice acquired by the voice acquiring unit; the voice-segment identifying unit, which identifies a voice segment from the start of the most-likely term recognized by the voice recognizing unit to a position at which the difference between the likelihood of the most-likely term and the likelihood of a second-most-likely term equals or exceeds a predetermined threshold; and the sound output controller, which controls sound output of the voice corresponding to the voice segment identified by the voice-segment identifying unit. The voice recognition apparatus consequently improves operability in user's device operation.

According to the other embodiment of the present invention, the voice recognition apparatus includes the following: the voice acquiring unit, which acquires a voice of a user; the voice recognizing unit, which recognizes a most-likely term from among a plurality of predetermined terms, with regard to the voice acquired by the voice acquiring unit; the character-string identifying unit, which identifies a character string from the start of the most-likely term recognized by the voice recognizing unit to a point at which the difference between the likelihood of the most-likely term and the likelihood of a second-most-likely term equals or exceeds a predetermined threshold; and the display controller, which controls display of the character string identified by the character-string identifying unit. The voice recognition apparatus consequently improves operability in user's device operation.

According to the still other embodiment of the present invention, the method of voice recognition includes the following: acquiring a voice of a user; recognizing a most-likely term from among a plurality of predetermined terms, with regard to the acquired voice; identifying a voice segment from the start of the recognized most-likely term to a position at which the difference between the likelihood of the most-likely term and the likelihood of a second-most-likely term equals or exceeds a predetermined threshold; and controlling sound output of the voice corresponding to the identified voice segment. The method consequently improves operability in user's device operation.

According to the further other embodiment of the present invention, the method of voice recognition includes the following: acquiring a voice of a user; recognizing a most-likely term from among a plurality of predetermined terms, with regard to the acquired voice; identifying a character string from the start of the recognized most-likely term to a position at which the difference between the likelihood of the most-likely term and the likelihood of a second-most-likely term equals or exceeds a predetermined threshold; and controlling display of the identified character string. The method consequently improves operability in user's device operation.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing an example of the configuration of a voice recognition apparatus according to a first embodiment of the present invention.

FIG. 2 is a block diagram showing an example of the configuration of a voice recognition apparatus according to the first embodiment of the present invention.

FIG. 3 is a block diagram showing an example of the hardware configuration of the voice recognition apparatus according to the first embodiment of the present invention.

FIG. 4 is a flowchart showing an example of the operation of the voice recognition apparatus according to the first embodiment of the present invention.

FIG. 5 is a diagram for use in describing the operation of the voice recognition apparatus according to the first embodiment of the present invention.

FIG. 6 is a diagram for use in describing the operation of the voice recognition apparatus according to the first embodiment of the present invention.

FIG. 7 is a block diagram showing an example of the configuration of a voice recognition apparatus according to a second embodiment of the present invention.

FIG. 8 is a block diagram showing an example of the configuration of a voice recognition apparatus according to the second embodiment of the present invention.

FIG. 9 is a block diagram showing an example of the hardware configuration of the voice recognition apparatus according to the second embodiment of the present invention.

FIG. 10 is a flowchart showing an example of the operation of the voice recognition apparatus according to the second embodiment of the present invention.

FIG. 11 is a block diagram showing an example of the configuration of a voice recognition system according to the embodiments of the present invention.

### DESCRIPTION OF EMBODIMENT(S)

The embodiments of the present invention will be described with reference to the drawings.

### First Embodiment

<Configuration>

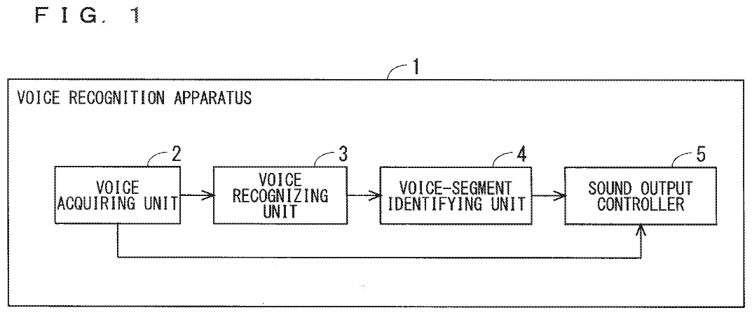

FIG. 1 is a block diagram showing an example of the configuration of a voice recognition apparatus 1 according to a first embodiment of the present invention. FIG. 1 shows a minimum number of components necessary for forming the voice recognition apparatus according to the first embodiment.

As shown in FIG. 1, the voice recognition apparatus 1 includes a voice acquiring unit 2, a voice recognizing unit 3, a voice-segment identifying unit 4, and a sound output controller 5. The voice acquiring unit 2 acquires a voice of a user. The voice recognizing unit 3 recognizes a most-likely term from among a plurality of predetermined terms, with regard to the voice acquired by the voice acquiring unit 2. The voice-segment identifying unit 4 identifies a voice segment from the start of the most-likely term recognized by the voice recognizing unit 3 to a position at which the difference between the likelihood of the most-likely term and the likelihood of a second-most-likely term equals or exceeds a predetermined threshold. The sound output controller 5 controls sound output of the voice corresponding to the voice segment identified by the voice-segment identifying unit 4.

The following describes the configuration of another voice recognition apparatus including the voice recognition apparatus 1 shown in FIG. 1.

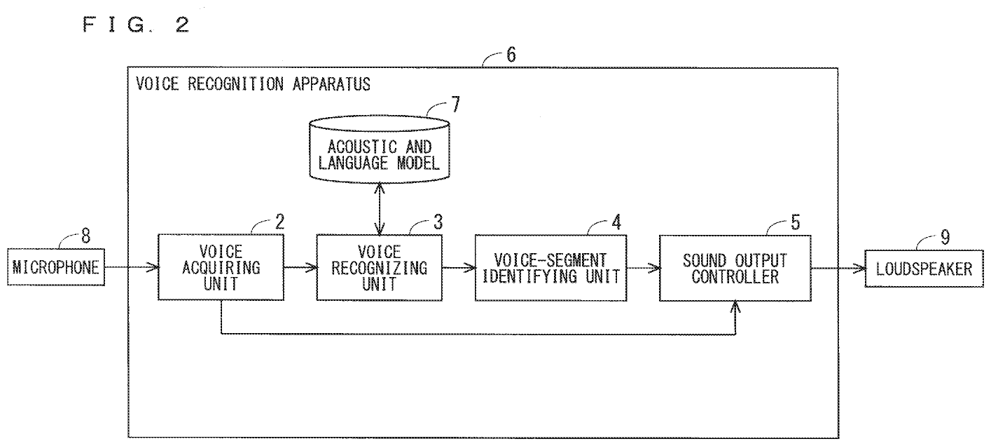

FIG. 2 is a block diagram showing an example of the configuration of a voice recognition apparatus 6.

As shown in FIG. 2, the voice recognition apparatus 6 includes the voice acquiring unit 2, the voice recognizing unit 3, the voice-segment identifying unit 4, the sound output controller 5, and an acoustic and language model 7. The voice acquiring unit 2 is connected to a microphone 8. The sound output controller 5 is connected to a loudspeaker 9.

The voice acquiring unit 2 acquires a voice uttered by a user through the microphone 8. For a user's voice in analog form, the voice acquiring unit 2 performs analog-to-digital conversion. It is noted that the voice acquiring unit 2 may perform noise reduction, beam forming or other processes, in order to exactly convert the user's voice in analog form into a digital form, such as a pulse-code-modulation (PCM) form.

The voice recognizing unit 3 recognizes a most-likely term from among a plurality of predetermined terms relating to device operations, with regard to the voice acquired by the voice acquiring unit 2. This voice recognition is performed using a known technique. For instance, the voice recognizing unit 3 extracts the amount of features of the voice acquired by the voice acquiring unit 2, followed by performing voice recognition using the acoustic and language model 7 in accordance with the extracted amount of voice features to determine a most-likely term.

To be specific, the voice recognizing unit 3 performs the following processes: (1) detecting the start of the user's vocalized voice and extracting the amount of features of the voice per unit time; (2) making a search using the acoustic and language model 7 on the basis of the extracted amount of features of the vocalized voice and calculating the probability of occurrence of each branch in a model tree; (3) calculating, in order, Processes (1) and (2) for each time series and repeating the calculation until detecting the end of the user's vocalized voice; and (4) converting a branch having the highest probability of occurrence in the end, i.e., a branch with the highest likelihood, into a character string and outputting, as a voice recognition result, a term that agrees with the character string.

The acoustic and language model 7 includes an acoustic model and a language model, and is a model in which the amount of voice features and the probability of occurrence of language character information, which is the chain thereof, are modeled in the form of a one-way tree structure by the use of a hidden Markov model (HMM) or other things. The acoustic and language model 7 is stored in a storage, such as a hard disk drive (HDD) or a semiconductor memory. The acoustic and language model 7, although included in the voice recognition apparatus 6 in the example of FIG. 2, may be located outside the voice recognition apparatus 6. The plurality of predetermined terms relating to device operations are entered in the acoustic and language model 7 in advance.

The voice-segment identifying unit 4 identifies a voice segment in which a most-likely term recognized by the voice recognizing unit 3 has higher likelihood than any other term. To be specific, the voice-segment identifying unit 4 compares the most-likely term recognized by the voice recognizing unit 3 with a second-most-likely term. The voice-segment identifying unit 4 then identifies a voice segment from the start of the most-likely term to a position at which the difference between the likelihoods of the most-likely term and second-most-likely term equals or exceeds a predetermined threshold.

The sound output controller 5 controls the loudspeaker 9 to output a sound of the voice corresponding to the voice segment identified by the voice-segment identifying unit 4. To be specific, the sound output controller 5 temporarily keeps the user's voice acquired by the voice acquiring unit 2, and controls the loudspeaker 9 to output the sound of the voice corresponding to the voice segment identified by the voice-segment identifying unit 4. The loudspeaker 9 outputs the sound of the voice under the control of the sound output controller 5.

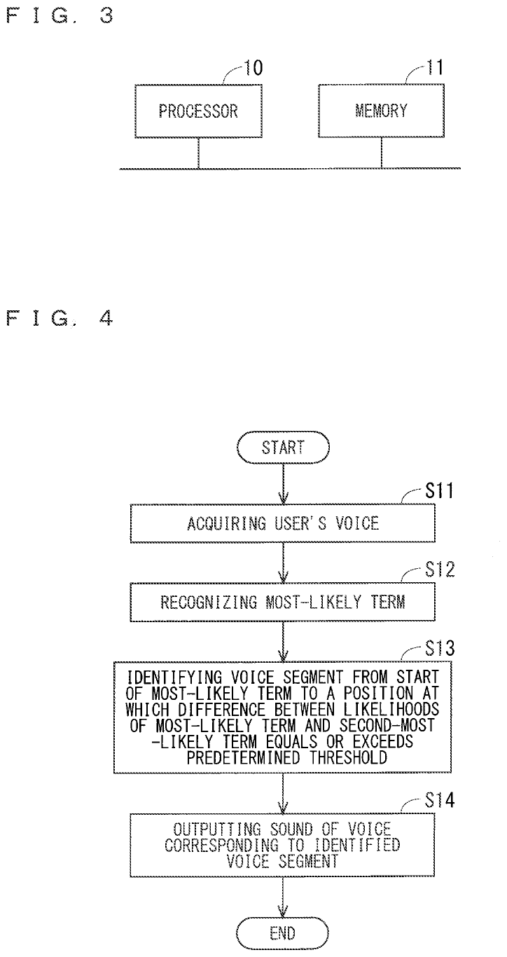

FIG. 3 is a block diagram showing an example of the hardware configuration of the voice recognition apparatus 6. This hardware configuration is similar to that of the voice recognition apparatus 1.

The functions of the voice acquiring unit 2, voice recognizing unit 3, voice-segment identifying unit 4, and sound output controller 5 of the voice recognition apparatus 6 are implemented by a processing circuit. That is, the voice recognition apparatus 6 includes a processing circuit for acquiring a voice of a user, recognizing a most-likely term, identifying a voice segment, and controlling sound output of the voice corresponding to the voice segment. The processing circuit is a processor 10 that executes a program stored in a memory 11. Examples of the processor 10 include a central processing unit, a processing unit, a computation unit, a microprocessor, a microcomputer, and a digital signal processor (DSP).

The functions of the voice acquiring unit 2, voice recognizing unit 3, voice-segment identifying unit 4, and sound output controller 5 of the voice recognition apparatus 6 are implemented by software, firmware, or a combination of software and firmware. The software or firmware is written as a program and stored in the memory 11. The processing circuit reads and executes the program stored in the memory 11, to implement the function of each component. That is, the voice recognition apparatus 6 includes the memory 11 for storing a program in which the following steps are executed: acquiring a voice of a user, recognizing a most-likely term; identifying a voice segment; and controlling sound output of the voice corresponding to the voice segment. The program is for a computer to execute the procedure or method of the voice acquiring unit 2, voice recognizing unit 3, voice-segment identifying unit 4, and sound output controller 5. The memory herein may be a volatile or non-volatile semiconductor memory (e.g., a random access memory or RAM for short, a read only memory or ROM for short, a flash memory, an erasable programmable read only memory or EPROM for short, or an electrically erasable programmable read only memory and EEPROM for short), a magnetic disk, a flexible disk, an optical disk, a compact disk, a mini disk, a DVD, or other things. Alternatively, the memory may be any kind of storing medium that will be used in the future.

<Operation>

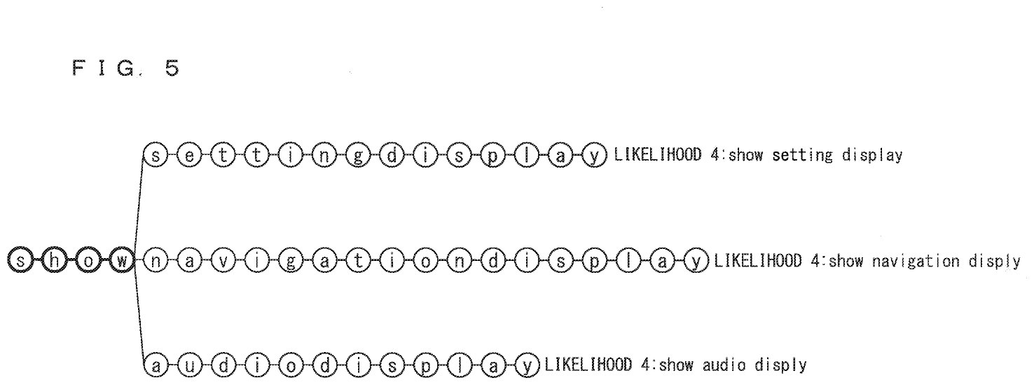

FIG. 4 is a flowchart showing an example of the operation of the voice recognition apparatus 6.

In Step S11, the voice acquiring unit 2 acquires a voice uttered by a user through the microphone 8. In Step S12, the voice recognizing unit 3 recognizes a most-likely term from among a plurality of predetermined terms relating to device operations, with regard to the voice acquired by the voice acquiring unit 2.

In Step S13, based on the result of the voice recognition in the voice recognizing unit 3, the voice-segment identifying unit 4 identifies a voice segment in which the most-likely term recognized by the voice recognizing unit 3 has higher likelihood than any other term.

Examples of the terms relating to device operations include “show setting display”, “show navigation display”, and “show audio display”. These terms are entered in the device in advance. By way of example, the most-likely term recognized by the voice recognizing unit 3 is herein “show setting display”. Here, the term “show setting display” indicates that a display is caused to show a setting screen on which various settings are made. The term “show navigation display” indicates that the display is caused to show a navigation screen relating to navigation. The term “show audio display” indicates that the display is caused to show an audio screen relating to audio.

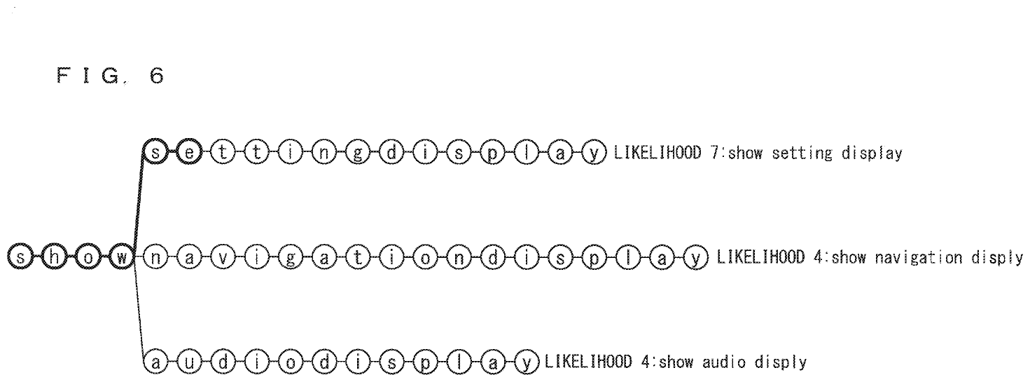

As shown in FIG. 5, at the time when the user has said, “show”, the voice recognizing unit 3 determines that all the terms “show setting display”, “show navigation display”, and “show audio display” have the same likelihood. All the terms at this time are under “Likelihood 4” by way of example. FIG. 5 and FIG. 6 (FIG. 6 will be described later on) depict user's vocalized voices, the sounds of which are divided into each alphabet for easy description.

As shown in FIG. 6, at the time when the user has said, “show se”, the voice recognizing unit 3 then determines that the term “show setting display” is very probable. At this stage, the term “show setting display” is under “Likelihood 7”, and the terms “show navigation display” and “show audio display are under “Likelihood 4”, by way of example. The voice-segment identifying unit 4 at this time determines that the likelihood of the term “show setting display” is higher than the likelihoods of the terms “show navigation display” and “show audio display”. In this way, the voice-segment identifying unit 4 compares a most-likely term, which is herein the term “show setting display”, with a second-most-likely term, which is herein the terms “show navigation display” and “show audio display”, to identify a voice segment from the start of the most-likely term to a position at which the difference between the likelihoods of the most-likely term and second-most-likely term equals or exceeds a predetermined threshold. The threshold of the difference between the likelihoods of both terms is herein set to be “2” by way of example. In the example of FIG. 6, the difference between the likelihood of the most-likely term “show setting display”, and the likelihoods of the second-most-likelihood terms “show navigation display” and “show audio display” is “3”, which equals or exceeds the threshold, “2”. The voice-segment identifying unit 4 accordingly identifies “show se” as a voice segment from the start to a position at which the difference between the likelihoods is “3”.

In Step S14, the sound output controller 5 controls the loudspeaker 9 to output a sound of the voice corresponding to the voice segment identified by the voice-segment identifying unit 4. This voice is the user's voice acquired by the voice acquiring unit 2 and temporarily kept in the sound output controller 5. The loudspeaker 9 outputs the sound of the voice under the control of the sound output controller 5. When the voice-segment identifying unit 4 identifies “show se” as a voice segment, for instance, the loudspeaker 9 outputs a sound, such as “Display the setting screen. Your utterance can be also recognized as ‘show se’”.

The foregoing description provides, by way of example only, values of likelihoods and a threshold of the difference between the likelihoods. These values and threshold each may be any value.

The foregoing has described, by way of example only, that the user utters in English. Any other languages, such as Japanese, German, and Chinese, may be used. In this case, terms relating to device operations corresponding to the individual languages are entered in the acoustic and language model 7 in advance.

<Modification>

The foregoing has described a non-limiting example where the voice-segment identifying unit 4 identifies a voice segment with a word divided at some midpoint, like a voice segment “show se”. The voice-segment identifying unit 4 may identify a voice segment on a word basis.

Referring to the term “show setting display” for instance, information about word sections such as “show/setting/display”, is previously entered in the acoustic and language model 7. The voice-segment identifying unit 4 then identifies a voice segment on a word basis, like a voice segment “show setting”, even when the voice recognizing unit 3 has uniquely identified the term “show setting display” in response to a user's utterance of “show se”. In this case, the loudspeaker 9 outputs a sound, such as “Display the setting screen. Your utterance can be also recognized as ‘show setting’”. Doing so enables a sound that has a meaning as a set of words to be output.

The voice recognition apparatus according to the first embodiment is configured such that the voice-segment identifying unit 4 compares a most-likely term with a second-most-likely term to identify a voice segment from the start of the most-likely term to a position at which the difference between the likelihoods of the most-likely term and second-most-likely term equals or exceeds a predetermined threshold. Under the control of the sound output controller 5, the loudspeaker 9 outputs a sound of the voice corresponding to the voice segment identified by the voice-segment identifying unit 4. Consequently, the user can understand that his/her utterance can be omitted when he/she operates the device by voice. The user can operate the device as intended, by exactly saying the sound of the voice corresponding to the voice segment identified by the voice-segment identifying unit 4. The voice recognition apparatus can be used not only in a limited situation like what is described in Patent Document 1, but also in any situation. The voice recognition apparatus also eliminates the need for time and effort to define abbreviations in advance like what is described in Patent Document 2. The voice recognition apparatus merely provides information indicating that a user's utterance can be omitted. Thus, the user never operates the device incorrectly like what is seen in Patent Document 2. The voice recognition apparatus according to the first embodiment improves operability when the user operates the device by voice.

### Second Embodiment

<Configuration>

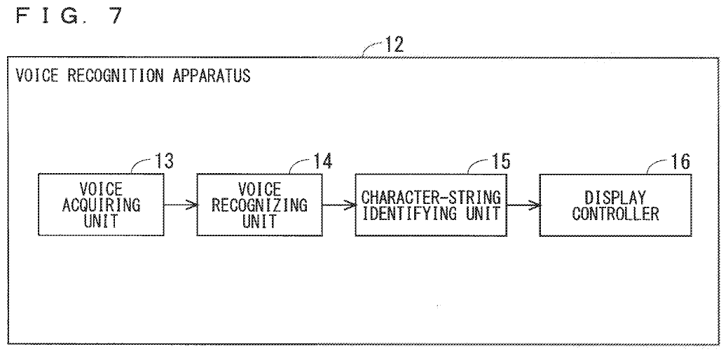

FIG. 7 is a block diagram showing an example of the configuration of a voice recognition apparatus 12 according to a second embodiment of the present invention. FIG. 7 shows a minimum number of components necessary for forming the voice recognition apparatus according to the second embodiment.

As shown in FIG. 7, the voice recognition apparatus 12 includes a voice acquiring unit 13, a voice recognizing unit 14, a character-string identifying unit 15, and a display controller 16. The voice acquiring unit 13 and the voice recognizing unit 14, which are similar to the voice acquiring unit 2 and voice recognizing unit 3 described in the first embodiment, will not be elaborated upon.

The character-string identifying unit 15 identifies a character string from the start of a most-likely term recognized by the voice recognizing unit 14 to a point at which the difference between the likelihood of the most-likely term and the likelihood of a second-most-likely term equals or exceeds a predetermined threshold. The display controller 16 controls display of the character string identified by the character-string identifying unit 15.

The following describes the configuration of another voice recognition apparatus including the voice recognition apparatus 1 shown in FIG. 7.

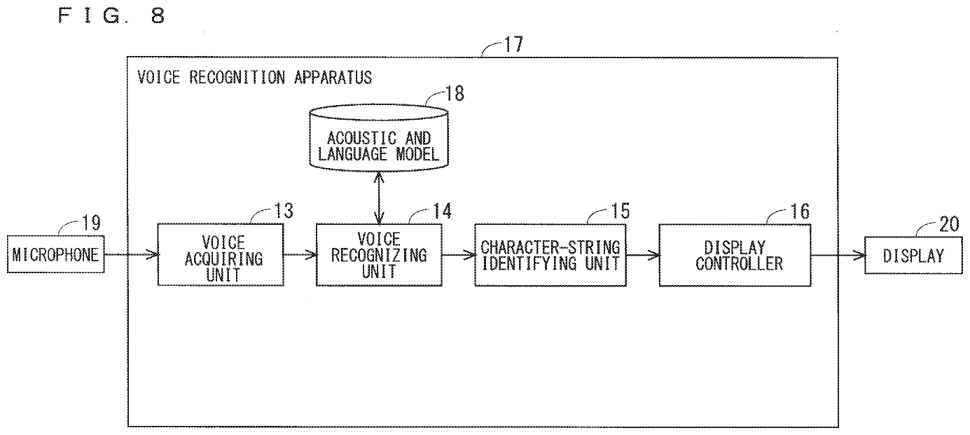

FIG. 8 is a block diagram showing an example of the configuration of a voice recognition apparatus 17.

As shown in FIG. 8, the voice recognition apparatus 17 includes the voice acquiring unit 13, the voice recognizing unit 14, the character-string identifying unit 15, the display controller 16, and an acoustic and language model 18. The voice acquiring unit 13 is connected to a microphone 19. The display controller 16 is connected to a display 20. The acoustic and language model 18, which is similar to the acoustic and language model 7 described in the first embodiment, will not be elaborated upon.

The character-string identifying unit 15 identifies a character string in which a most-likely term recognized by the voice recognizing unit 14 has higher likelihood than any other term. To be specific, the character-string identifying unit 15 compares a most-likely term recognized by the voice recognizing unit 14 with a second-most-likely term. The character-string identifying unit 15 then identifies a character string from the start of the most-likely term to a point at which the difference between the likelihood of the most-likely term and the likelihood of the second-most-likely term equals or exceeds a predetermined threshold.

The display controller 16 controls the display 20 to show the character string identified by the character-string identifying unit 15. The display 20 shows the character string under the control of the display controller 16.

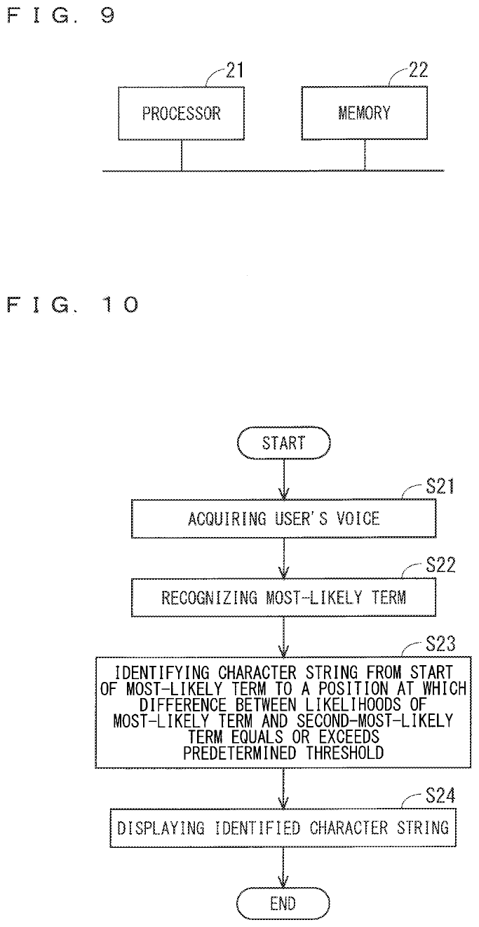

FIG. 9 is a block diagram showing an example of the hardware configuration of the voice recognition apparatus 17. This hardware configuration is similar to that of the voice recognition apparatus 12.

The functions of the voice acquiring unit 13, voice recognizing unit 14, character-string identifying unit 15, and display controller 16 of the voice recognition apparatus 17 are implemented by a processing circuit. That is, the voice recognition apparatus 17 includes a processing circuit for acquiring a voice of a user, recognizing a most-likely term, identifying a character string, and controlling display of the character string. The processing circuit is a processor 21 that executes a program stored in a memory 22. Examples of the processor 21 include a central processing unit, a processing unit, a computation unit, a microprocessor, a microcomputer, and a DSP.

The functions of the voice acquiring unit 13, voice recognizing unit 14, character-string identifying unit 15, and display controller 16 of the voice recognition apparatus 17 are implemented by software, firmware, or a combination of software and firmware. The software or firmware is written as a program and stored in the memory 22. The processing circuit reads and executes the program stored in the memory 22, to implement the function of each component. That is, the voice recognition apparatus 17 includes the memory 22 for storing a program in which the following steps are executed: acquiring a voice of a user, recognizing a most-likely term; identifying a character string; and controlling display of the character string. The program is for a computer to execute the procedure or method of the voice acquiring unit 13, voice recognizing unit 14, character-string identifying unit 15, and display controller 16. The memory herein may be a volatile or non-volatile semiconductor memory (e.g., a RAM, a ROM, a flash memory, an EPROM, and an EEPROM), a magnetic disk, a flexible disk, an optical disk, a compact disk, a mini disk, a DVD, or other things. Alternatively, the memory may be any kind of storing medium that will be used in the future.

<Operation>

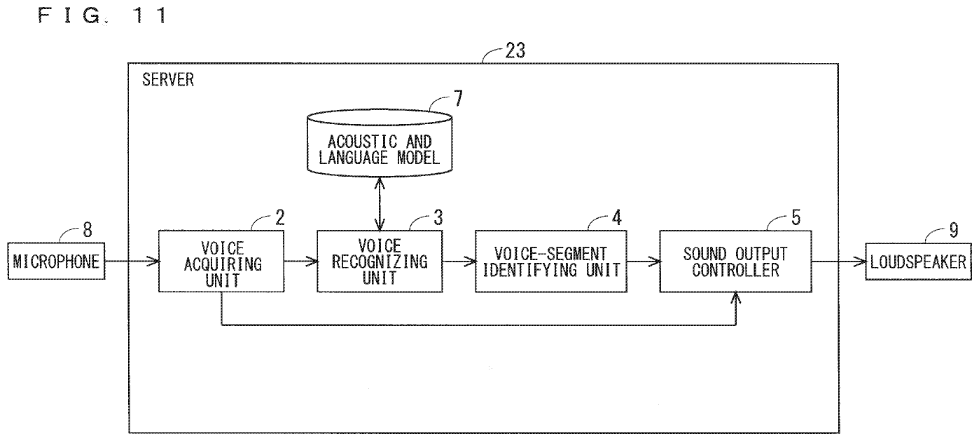

FIG. 10 is a flowchart showing an example of the operation of the voice recognition apparatus 17. Steps S21 and S22 in FIG. 10, which respectively correspond to Steps S11 and S12, will not be elaborated upon. Steps S23 and S24 will be described herein.

In Step S23, based on the result of the voice recognition in the voice recognizing unit 14, the character-string identifying unit 15 identifies a character string in which the most-likely term recognized by the voice recognizing unit 14 has higher likelihood than any other term. How the character-string identifying unit 15 identifies the character string is similar to how the voice-segment identifying unit 4 in the first embodiment identifies a voice segment.

For instance, as shown in FIG. 6, at the time when the user has said, “show se”, the voice recognizing unit 14 determines that the term “show setting display” is very probable. At this stage, the term “show setting display” is under “Likelihood 7”, and the terms “show navigation display” and “show audio display” are under “Likelihood 4”. The character-string identifying unit 15 at this time determines that the likelihood of the term “show setting display” is higher than the likelihoods of the terms “show navigation display” and “show audio display”. In this way, the character-string identifying unit 15 compares a most-likely term, which is herein the term “show setting display”, with a second-most-likely term, which is herein the terms “show navigation display” and “show audio display”, to identify a character string from the start of the most-likely term to a position at which the difference between the likelihoods of the most-likely term and second-most-likely term equals or exceeds a predetermined threshold. The threshold of the difference between the likelihoods of both terms is herein set to be “2” by way of example. In the example of FIG. 6, the difference between the likelihood of the most-likely term “show setting display”, and the likelihoods of the second-most-likelihood terms “show navigation display” and “show audio display” is “3”, which equals or exceeds the threshold, “2”. The character-string identifying unit 15 accordingly identifies “show se” as a character string from the start to a position at which the difference between the likelihoods is “3”.

In Step S24, the display controller 16 controls the display 20 to show the character string identified by the character-string identifying unit 15. The display 20 shows the character string under the control of the display controller 16. When the character-string identifying unit 15 identifies “show se” as a character string, for instance, the display 20 shows a phrase, such as “Display the setting screen. Your utterance can be also recognized as ‘show se’”.

The foregoing description provides, by way of example only, values of likelihoods and a threshold of the difference between the likelihoods. These values and threshold each may be any value.

The foregoing has described, by way of example only, that the user utters in English. Any other languages, such as Japanese, German, and Chinese, may be used. In this case, terms relating to device operations corresponding to the individual languages are entered in the acoustic and language model 18 in advance.

<Modification>

The foregoing has described a non-limiting example where the character-string identifying unit 15 identifies a character string with a word divided at some midpoint, like a character string “show se”. The character-string identifying unit 15 may identify a character string on a word basis.

Referring to the term “show setting display” for instance, information about word sections such as “show/setting/display”, is previously entered in the acoustic and language model 18. The character-string identifying unit 15 then identifies a character string on a word basis, like a character string “show setting”, even when the voice recognizing unit 14 has uniquely identified the term “show setting display” in response to a user's utterance of “show se”. In this case, the display 20 shows a phrase, such as “Display the setting screen. Your utterance can be also recognized as ‘show setting’”. Doing so enables a character string that has a meaning as a set of words to be displayed.

The voice recognition apparatus according to the second embodiment is configured such that the character-string identifying unit 15 compares a most-likely term with a second-most-likely term to identify a character string from the start of the most-likely term to a position at which the difference between the likelihoods of the most-likely term and second-most-likely term equals or exceeds a predetermined threshold. Under the control of the display controller 16, the display 20 shows the character string identified by the character-string identifying unit 15. Consequently, the user can understand that his/her utterance can be omitted when he/she operates the device by voice. The user can operate the device as intended, by exactly saying the character string identified by the character-string identifying unit 15. The voice recognition apparatus can be used not only in a limited situation like what is described in Patent Document 1, but also in any situation. The voice recognition apparatus also eliminates the need for time and effort to define abbreviations in advance like what is described in Patent Document 2. The voice recognition apparatus merely provides information indicating that a user's utterance can be omitted. Thus, the user never operates the device incorrectly like what is seen in Patent Document 2. The voice recognition apparatus according to the second embodiment improves operability when the user operates the device by voice.

The aforementioned voice recognition apparatuses each can be included not only in a vehicle-mounted navigation device (i.e., an in-vehicle navigation device), but also in a vehicle-mountable portable navigation device (PND), a vehicle-mountable portable communication terminal (e.g., a mobile phone, a smartphone, and a tablet terminal), and a navigation device or any device other than such a navigation device formed as a system in combination with an external server and other things as appropriate. In this case, the functions or components of the voice recognition apparatus are distributed, for placement, to respective functions that constitute the above system.

To be specific, the functions of the voice recognition apparatus can be placed on a server, for instance. As illustrated in FIG. 11 for instance, a user interface includes the microphone 8 and the loudspeaker 9. A server 23 includes the voice acquiring unit 2, the voice recognizing unit 3, the voice-segment identifying unit 4, the sound output controller 5, and the acoustic and language model 7. Such a configuration enables a voice recognition system to be established. The same holds true for the voice recognition apparatus 17 shown in FIG. 8.

The above configuration, in which the functions of the voice recognition apparatus are distributed, for placement, to the respective functions constituting the system, still achieves an effect similar to that described in the foregoing embodiment.

Software that executes the operation described in each of the foregoing embodiments may be incorporated to a server for instance. The server executes this software to implement a method of voice recognition. The method includes the following: acquiring a voice of a user; recognizing a most-likely term from among a plurality of predetermined terms, with regard to the acquired voice; identifying a voice segment from the start of the recognized most-likely term to a position at which the difference between the likelihood of the most-likely term and the likelihood of a second-most-likely term equals or exceeds a predetermined threshold; and controlling sound output of the voice corresponding to the identified voice segment. The server executes this software to implement another method of voice recognition. The method includes the following: acquiring a voice of a user; recognizing a most-likely term from among a plurality of predetermined terms, with regard to the acquired voice; identifying a character string from the start of the recognized most-likely term to a position at which the difference between the likelihood of the most-likely term and the likelihood of a second-most-likely term equals or exceeds a predetermined threshold; and controlling display of the identified character string.

In this way, incorporating software that executes the operation described in each of the foregoing embodiments into a server for operation achieves an effect similar to that described in the aforementioned embodiments.

The individual embodiments of the present invention can be freely combined, or can be modified and omitted as appropriate, within the scope of the invention.

While the invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

1 voice recognition apparatus, 2 voice acquiring unit, 3 voice recognizing unit, 4 voice-segment identifying unit, 5 sound output controller, 6 voice recognition apparatus, 7 acoustic and language model, 8 microphone, 9 loudspeaker, 10 processor, 11 memory, 12 voice recognition apparatus, 13 voice acquiring unit, 14 voice recognizing unit, 15 character string identifying unit, 16 display controller, 17 voice recognition apparatus, 18 acoustic and language model, 19 microphone, 20 display, 21 processor, 22 memory, 23 server.

1. A voice recognition apparatus comprising:
a processor to execute a program; and
a memory to store the program which, when executed by the processor, performs processes of,
acquiring a voice of a user,
recognizing a most-likely term from among a plurality of predetermined terms, with regard to the acquired voice,
identifying a voice segment from a start of the recognized most-likely term to a position at which a difference between a likelihood of the most-likely term and a likelihood of a second-most-likely term equals or exceeds a predetermined threshold, and
controlling sound output of the voice corresponding to the identified voice segment identified by the voice segment identifying unit.

2. The voice recognition apparatus according to claim 1, wherein the identifying process comprises identifying the voice segment on a word basis.

3. A voice recognition apparatus comprising:
a processor to execute a program; and
a memory to store the program which, when executed by the processor, performs processes of,
acquiring a voice of a user,
recognizing a most-likely term from among a plurality of predetermined terms, with regard to the acquired voice,
identifying a character string from a start of the recognized most-likely term to a position at which a difference between a likelihood of the most-likely term and a likelihood of a second-most-likely term equals or exceeds a predetermined threshold, and
controlling display of the identified character string.

4. The voice recognition apparatus according to claim 3, wherein the identifying process comprises identifying the character string on a word basis.

5. A method of voice recognition, comprising:
acquiring a voice of a user;
recognizing a most-likely term from among a plurality of predetermined terms, with regard to the acquired voice;
identifying a voice segment from a start of the recognized most-likely term to a position at which a difference between a likelihood of the most-likely term and a likelihood of a second-most-likely term equals or exceeds a predetermined threshold; and
controlling sound output of the voice corresponding to the identified voice segment.

6. A method of voice recognition, comprising:
acquiring a voice of a user;
recognizing a most-likely term from among a plurality of predetermined terms, with regard to the acquired voice;
identifying a character string from a start of the recognized most-likely term to a position at which a difference between a likelihood of the most-likely term and a likelihood of a second-most-likely term equals or exceeds a predetermined threshold; and
controlling display of the identified character string.
